(19) United States
(12) Patent Application Publication
(10) Pub. No.: US 2021/0195382 A1
(43) Pub. Date: Jun. 24, 2021

(54) NETWORK NODE, MBMS NODE AND METHODS PERFORMED THEREIN

(71) Applicant: Telefonaktiebolaget LM Ericsson (publ), Stockholm (SE)

(72) Inventor: Hanbing Zhang, Göteborg (SE)

(21) Appl. No.: 17/272,326

(22) PCT Filed: Aug. 27, 2018
(86) PCT No.: PCT/EP2018/072984

§ 371 Date: Feb. 28, 2021

(51) Int. Cl. H04W 4/06; H04W 8/08; H04W 48/16; H04W 88/16

(52) U.S. Cl. CPC H04W 4/06; H04W 88/16; H04W 48/16; H04W 8/08

(57) ABSTRACT

A network node, a Multimedia Broadcast and Multicast Service (MBMS) node and methods performed therein are provided. A method performed by a network node for communicating with a Multimedia Broadcast and Multicast Service (MBMS) node, the method comprising: receiving, via a service-based interface between the network node and the MBMS node, the MBMS session request from the MBMS node; and sending via the service-based interface the MBMS session response to the MBMS node.

### TECHNICAL FIELD

Embodiments herein relate to a network node, a Multimedia Broadcast and Multicast Service (MBMS) node and methods performed therein. Furthermore, a computer program product and a computer readable storage medium are also provided herein. In particular, embodiments herein relate to MBMS.

### BACKGROUND

In a typical wireless communication network, wireless devices, also known as wireless communication devices, mobile stations, stations (STA) and/or user equipments (UE), communicate via a Radio Access Network (RAN) to one or more core networks (CNs). The RAN covers a geographical area which is divided into service areas or cells, with each service area or cell being served by a radio network node such as a radio access node e.g., a Wi-Fi access point or a radio base station (RBS), which in some networks may also be denoted, for example, a NodeB (NB), an enhanced NodeB (eNodeB), or a gNodeB (gNB). A service area or cell is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for wireless devices. In a forum known as the Third Generation Partnership Project (3GPP), telecommunications suppliers propose and agree upon standards for third generation networks, and investigate enhanced data rate and radio capacity. In some RANs, e.g., as in UTRAN, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g., eNodeBs in LTE, and the core network. As such, the RAN of an EPS has an essentially “flat” architecture comprising radio network nodes connected directly to one or more core networks, i.e., they are not connected to RNCs. To compensate for that, the E-UTRAN specification defines a direct interface between the radio network nodes, this interface being denoted the X2 interface. New generation radio (NR) is a new radio access technology being standardized in 3GPP.

Multimedia Broadcast and Multicast Service (MBMS) is a broadcasting service offered via a wireless communication network. MBMS may be used for broadcasting or multicasting TV, films, and other information such as overnight transmission of newspapers in a digital form.

MBMS Service Requirements for the Fifth Generation System, denoted as 5GS, or 5G System. According to 3GPP Technical Specification (TS) 22.261-V16.1.0, the 5GS will support flexible broadcast or multicast services because the proliferation of video services, ad-hoc multicast/broadcast streams, software delivery over wireless, group communications and broadcast/multicast Internet of Things (IoT) applications have created a need for a flexible and dynamic allocation of radio resources between unicast and multicast services within the network as well as support for a stand-alone deployment of multicast or broadcast networks. Moreover, enabling such a broadcast or multicast service over a network for a wide range of inter-site distances between the radio base stations will enable a more efficient and effective delivery system for real-time and streaming multicast or broadcast content over wide geographic areas as well as in specific geographic areas spanning a limited number of base stations. A flexible multicast or broadcast service will allow the 5G System to efficiently deliver such services.

Here is a list of MBMS service requirements on 5G System according to 3GPP TS 22.261 V16.1.0.
The 5G System shall support operation of downlink only broadcast or multicast over a specific geographic area (e.g., a cell sector, a cell or a group of cells).
The 5G System shall support operation of a downlink only broadcast or multicast system over a wide geographic area in a spectrally efficient manner for stationary and mobile UEs.
The 5G System shall enable the operator to reserve 0% to 100% of radio resources of one or more radio carriers for the delivery of broadcast or multicast content.
The 5G System shall allow the UE to receive content via a broadcast or multicast radio carrier while a concurrent data session is ongoing over another radio carrier.
   The 5G System shall be able to support broadcast or multicast of Ultra High-Definition (UHD) streaming video (e.g., 4K or 8K UHD).
The 5G System shall allow the operator to configure and broadcast multiple quality levels (i.e., video resolutions) of broadcast or multicast content for the same user service in a stand-alone 3GPP based broadcast or multicast system.
The 5G System shall support parallel transfer of multiple quality levels (i.e., video resolutions) of broadcast or multicast content for the same user service to the same UE taking into account e.g., UE capability, radio characteristics, application information.
The 5G System shall support parallel transfer of multiple multicast or broadcast user services to a UE.
The 5G System shall support a stand-alone multicast or broadcast network comprising of multiple cells with inter-site distances of up to 200 km.

### 5G System Architecture Reference Model

According to 3GPP TS 23.501 V15.2.0, the 5G System architecture is defined as service-based and interaction between Network Functions (NFs) may be represented in two ways.
a service-based interface representation, where NFs (e.g., Access and Mobility Management Function (AMF)) within a Control Plane enable other NFs to access their services. This representation may also include point-to-point reference points where necessary.
a reference point representation shows interactions between the NF services in the NFs described by a point-to-point reference point (e.g., N11) between two NFs (e.g., AMF and Session Management Function (SMF)).

The disclosure herein is related to the service-based interface representation.

The term reference point may refer to an abstract point (or plan) in a model of a network or architecture. The reference point may serve to partition NFs or configurations and so assist in the description of the architecture, as well as serve as a point of interoperability between different network functions of the architecture. On the other hand, the term interface may refer to a physical partition between different physical network elements. However, the terms interface and reference point are interchangeable herein in this disclosure, they may serve to partition both logical NFs and physical network elements.

Throughout this disclosure, the term reference point will always refer to a non-service-based interface, except for being explicitly limited to the service-based interface.

A NF service is one type of capability exposed by a NF (NF Service Producer) to other authorized NF (NF Service Consumer) through a service-based interface. A NF service may support one or more NF service operation(s).

A system architecture in which the system functionality is achieved by utilizing a set of services is termed as a service based architecture.

A service-based interface represents how the set of services is provided or exposed by a given NF. This is the interface where the NF service operations are invoked. The following Control Plane interfaces within the 5G Core Network (5GC) specified in 3GPP TS 23.501 are defined as service-based interfaces: Namf, Nsmf, Nudm, Nnrf, Nnssf, Nausf, Nnef, Nsmsf, Nudr, Npcf, N5g-eir, Nlmf. The service-based interfaces may use HTTP/2 protocol with JSON as the application layer serialization protocol.

FIG. 1 depicts a non-roaming reference architecture, where service-based interfaces are used within the Control Plane. The 5G System architecture may comprise the following NFs.
Authentication Server Function (AUSF)
Access and Mobility Management Function (AMF)
Data Network (DN), e.g., operator services, Internet access or 3rd party services
Unstructured Data Storage Function (UDSF)
Network Exposure Function (NEF)
NF Repository Function (NRF)
Network Slice Selection Function (NSSF)
Policy Control Function (PCF)
Session Management Function (SMF)
Unified Data Management (UDM)
Unified Data Repository (UDR)
User Plane Function (UPF)
Application Function (AF)
User Equipment (UE)
(Radio) Access Network ((R)AN)
5G-Equipment Identity Register (5G-EIR)
Security Edge Protection Proxy (SEPP)

The functional description of these NFs is specified in 3GPP TS 23.501 V15.1.0, clause 6. Definitions for the service-based interfaces can be found in 3GPP TS 23.501 V15.1.0, clause 4.2.6.

### SUMMARY

An object of embodiments herein is to provide a mechanism for improving performance of the wireless communication network to provide the MBMS.

According to an aspect the object is achieved by providing a method performed by a network node, for communicating with a MBMS node. The network node receives, via a service-based interface between the network node and the MBMS node, an MBMS session request from the MBMS node. The network node also sends via the service-based interface an MBMS session response to the MBMS node.

According to another aspect the object is achieved by providing a method performed by a MBMS node, for communicating with a network node. The MBMS node sends, via a service-based interface between the network node and the MBMS node, an MBMS session request to the network node. The MBMS node also receives via the service-based interface an MBMS session response from the network node.

According to still another aspect the object is achieved by providing a network node for communicating with a MBMS node. The network node is configured to receive, via a service-based interface between the network node and the MBMS node, an MBMS session request from the MBMS node. The network node is also configured to send via the service-based interface an MBMS session response to the MBMS node.

According to yet another aspect the object is achieved by providing a MBMS node for communicating with a network node. The MBMS node is configured to send, via a service-based interface between the network node and the MBMS node, an MBMS session request to the network node. The MBMS node is also configured to receive via the service-based interface an MBMS session response from the network node.

It is furthermore provided herein a computer program product comprising instructions, which, when executed on at least one processor, cause the at least one processor to carry out any of the methods above, as performed by the network node or the MBMS node. It is additionally provided herein a computer-readable storage medium, having stored thereon a computer program product comprising instructions which, when executed on at least one processor, cause the at least one processor to carry out the method according to any of the methods above, as performed by the network node or the MBMS node.

According to still another aspect the object is achieved by providing a network node comprising processing circuitry configured to receive, via a service-based interface between the network node and the MBMS node, an MBMS session request from the MBMS node. The processing circuitry is also configured to send via the service-based interface an MBMS session response to the MBMS node.

According to still another aspect the object is achieved by providing a MBMS node comprising processing circuitry configured to send, via a service-based interface between the network node and the MBMS node, an MBMS session request to the network node. The processing circuitry is also configured to receive via the service-based interface an MBMS session response from the network node.

Comparing with non-service-based interface between a network node in a service-based CN and a MBMS node, the network node herein with a service-based interface towards the MBMS node will take the advantage of the service-based CN, e.g., 5GC, and will be less complicated.

### BRIEF DESCRIPTION OF THE DRAWINGS

Embodiments will now be described in more detail in relation to the enclosed drawings, in which:

FIG. 1 is a schematic overview depicting a non-roaming MBMS System Architecture using service-based interface representation;

FIG. 2 is a schematic depicting a MBMS system according to embodiments herein;

FIG. 3a depicts a MBMS system architecture without MBMS-IWF using a reference point representation according to embodiments herein;

FIG. 3b depicts a MBMS system architecture without MBMS-IWF using a service-based interface representation according to embodiments herein;

FIG. 4 is a protocol stack of a service-based interface according to embodiments herein;

FIG. 5a depicts a MBMS system architecture with MBMS-IWF using a reference point representation according to embodiments herein;

FIG. 5b depicts a MBMS system architecture with MBMS-IWF using a service-based interface representation according to embodiments herein;

FIG. 6a is a flowchart depicting methods performed by a network node according to embodiments herein;

FIG. 6b is a flowchart depicting methods performed by a MBMSF according to embodiments herein;

FIG. 6c is a combined signalling scheme and flowchart according to embodiments herein;

FIG. 6d is a combined signalling scheme and flowchart at HTTP/2 layer according to embodiments herein;

FIG. 7a is a flowchart depicting methods performed by a MBMS-IWF according to embodiments herein;

FIG. 7b is a combined signalling scheme and flowchart according to embodiments herein;

FIG. 8 is a block diagram depicting a network node according to embodiments herein;

FIG. 9 is a block diagram depicting a MSMB node according to embodiments herein; and

FIG. 10-FIG. 15 are flowcharts illustrating methods implemented in a communication system including a host computer, a base station and a user equipment.

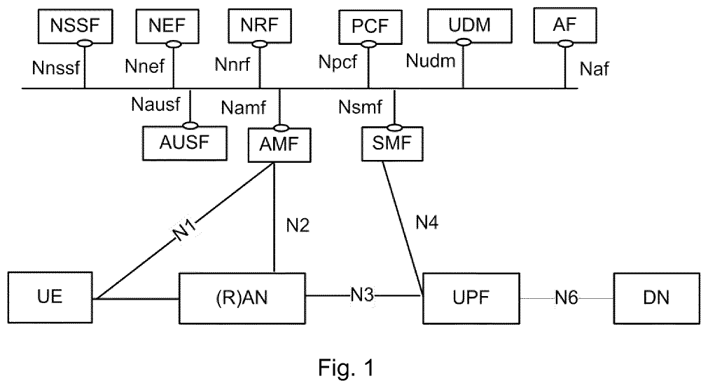

### DETAILED DESCRIPTION

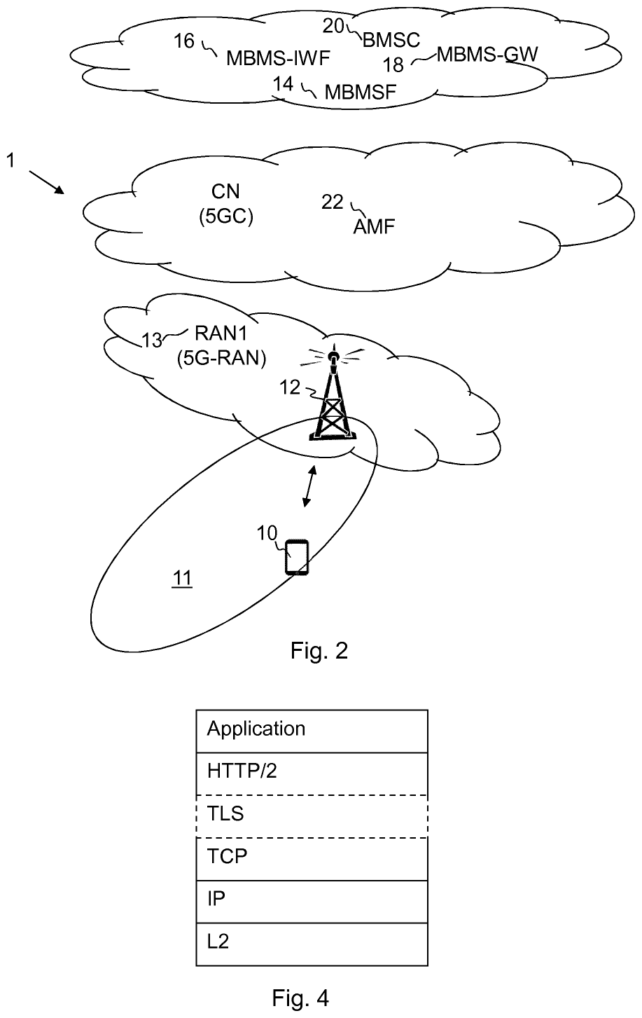

FIG. 2 is a schematic overview depicting a MBMS system comprising a wireless communication network 1. The wireless communication network 1 comprises one or more RANs e.g., a first RAN (RAN1), connected to one or more CNs, e.g., 5G core networks (5GCs). The wireless communication network 1 may use one or more technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g., 3G and LTE.

In the wireless communication network 1, wireless devices e.g., a wireless device 10 such as a mobile station, a non-access point (non-AP) station (STA), a STA, a user equipment (UE) and/or a wireless terminal, are connected via the one or more RANs, to the one or more CNs, e.g., 5GCs. It should be understood by those skilled in the art that “wireless device” is a non-limiting term which means any terminal, wireless communication terminal, communication equipment, Machine Type Communication (MTC) device, Device to Device (D2D) terminal, or user equipment e.g., smart phone, laptop, mobile phone, sensor, relay, mobile tablets or any device communicating within a cell or service area. The wireless device searches for carriers using a carrier raster. The carrier raster indicating possible frequency positions of a carrier for the wireless device

The wireless communication network 1 comprises a radio network node 12. The radio network node 12 is exemplified herein as a RAN node providing radio coverage over a geographical area, a service area 11, of a radio access technology (RAT), such as NR, LTE, UMTS, Wi-Fi or similar. The radio network node 12 may be a radio access network node such as radio network controller or an access point such as a wireless local area network (WLAN) access point or an Access Point Station (AP STA), an access controller, a base station, e.g., a radio base station such as a NodeB, a gNodeB, an evolved Node B (eNB, eNodeB), a base transceiver station, Access Point Base Station, base station router, a transmission arrangement of a radio base station, a stand-alone access point or any other network unit capable of serving a wireless device 10 within the service area served by the radio network node 12 depending e.g., on the radio access technology and terminology used and may be denoted as a receiving radio network node.

As shown in FIG. 2, the MBMS system may also comprise a Broadcast Multicast Service Centre (BMSC) 20 and various MBMS node, such as an MBMSF 14 and/or an MBMS-IWF 16. The MBMS may be delivered through a service-based CN, e.g., 5GC. In the service-based CN, a controlling network node, e.g., an AMF 22, may be employed to facilitate the MBMS from the BMSC 20 via the MBMS node, such as the MBMSF 14 and/or the MBMS-IWF 16. The terms controlling network node and network node are interchangeable herein in this disclosure.

As part of developing embodiments herein, a problem will first be identified and shortly discussed.

Embodiments herein relate to wireless communication networks in general, particularly to MBMS in a wireless communication network. However how the above MBMS service requirements can be fulfilled by a wireless communication network having a service-based CN, e.g., 5GC, has not been defined in 3GPP. For the ease of reading, embodiments herein will described in the context of 5G System, however the skilled person will appreciate that the embodiments herein are also applied to other wireless communication system.

According to embodiments herein, a service-based interface, e.g., Nxx, will be added between the network node, e.g., the AMF 22, and a MBMS node. By doing this, the embodiments will take the advantage of the service-based CN, e.g., 5GC. Moreover, comparing with non-service-based interface between the MBMS node and the AMF 22, the service-based interface will make the network node, e.g., AMF 22, implementation architecture simplifier.

According to some embodiments herein, a new MBMS node which is a logical network function may also be added between the existing MBMS node and the network node. Due to an existing interface between the existing MBMS node and the network node is a non-service-based interface, new MBMS node will bring the technical advantage of translating between the service-based interface and the non-service-based interface.

The newly added MBMS node may be a Multimedia Broadcast and Multicast Service Function (MBMSF) or a Multimedia Broadcast and Multicast Service-InterWorking Function (MBMS-IWF).

The MBMSF may be a logical NF configured to provide the MBMS-GW functionality to the network node with the service-based interface.

The MBMS-IWF is a logical NF between the network node and the MBMS-GW. The MBMS-IWF may be configured with the service-based interface towards the network node and the non-service-based interface towards the MBMS-GW. In other words, the MBMS-IWF may be configured to translate between the service-based interface and the non-service-based interface.

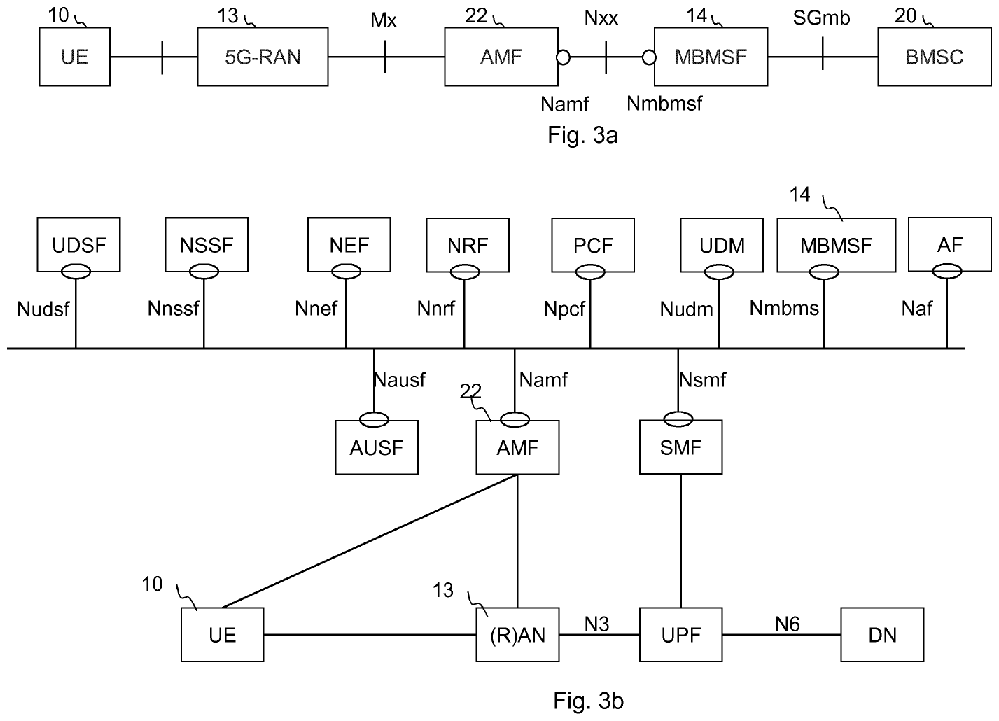

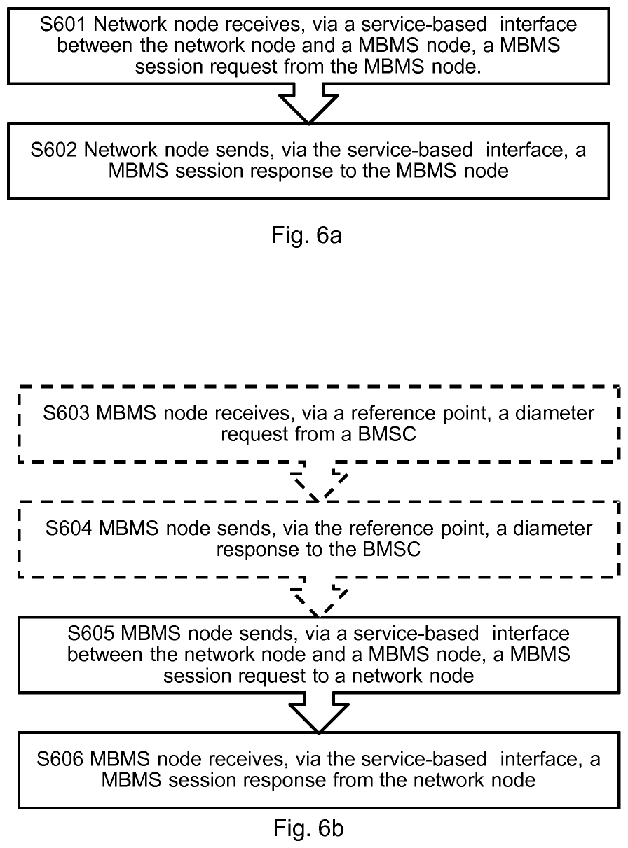

Within the service-based CN, e.g., 5GC, the network node according to embodiments herein may offer services to the newly added MBMS node, either directly to a MBMSF shown in FIG. 3a or to MBMS-GW via a MBMS-IWF shown in FIG. 5a.

According to some embodiments, it may be further proposed to reuse the Namf_Communication service in the control plane for an MBMS session Control Procedure (will be discussed in detail later) between the network node and the newly added MBMS node. In other words, a technical advantage of some embodiments is that the AMF service Namf_Communication is reused.

Furthermore, some embodiments herein may have the further technical advantage of being compatible with the existing standard. That is because one of the design guidelines for NF services according to 3GPP TS 23.502 V15.2.0 is that the NF services are reusable, meaning that the NF service operations of a NF service are specified such that other NF can potentially invoke them in future, if required. Therefore the embodiments herein are compatible with the existing standard.

MBMS System Architecture without MBMS-IWF

FIG. 3a depicts a MBMS system architecture without MBMS-IWF using the reference point representation showing how the NFs interact with each other. Meanwhile, FIG. 3b depicts a MBMS system architecture without MBMS-IWF using the service-based interface representation.

The service-based interface, e.g., Nxx, is between the network node, e.g., an AMF 22, and the MBMSF 14. Specifically, the Nxx may be referred to as a service-based interface exhibited by the AMF 22, shown as Namf, and/or a service-based interface exhibited by the MBMSF 14, shown as Nmbms.

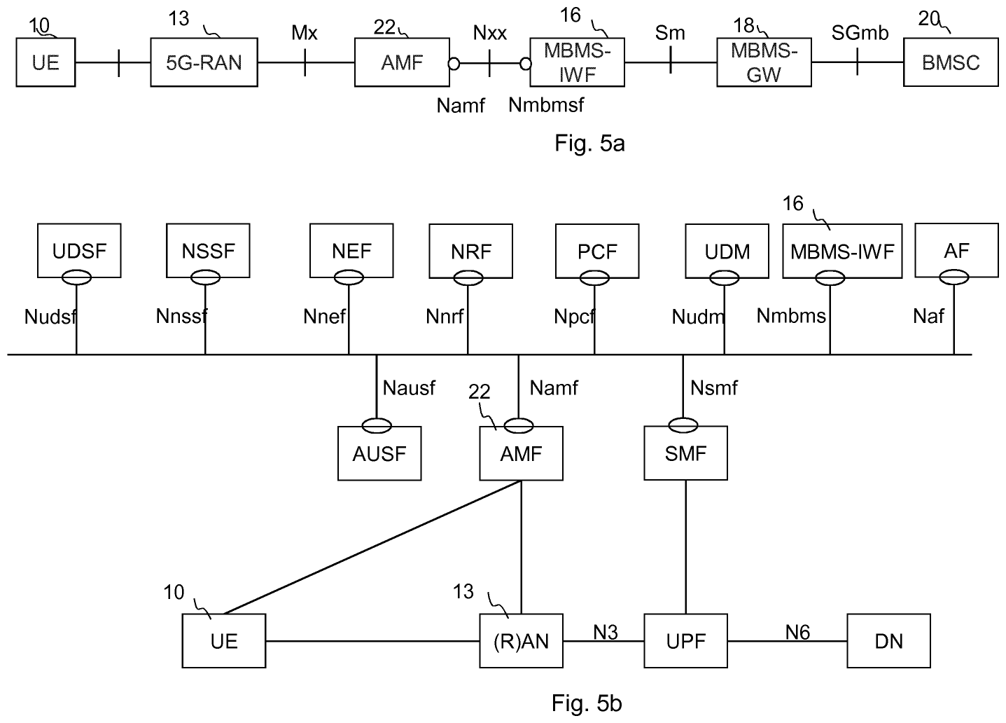

The service-based interface, e.g., Nxx may use the service-based interface (SBI) protocol stack as other service-based interface. For instance, as shown in FIG. 4, the protocol stack of the service-based interface, e.g., Nxx, may comprise different lays, such as Application, Hypertext Transfer Protocol (HTTP)/2, Transport Layer Security (TLS), Transmission Control Protocol (TCP), Internet protocol (IP), and lay 2 (L2), more details about the SBI protocol stack are defined in 3GPP TS 29.500 V15.0.0.

A non-service-based interface Mx is an interface between the AMF 22 and the RAN, e.g., 5G-RAN 13, for MBMS session control. The non-service-based interface Mx may be corresponding to the prior art M3 reference point which is between a Mobility Management Entity (MME) and a Multi-cell or multicast Coordination Entity (MCE) in an Evolved Packet System (EPS) network. The skilled persons will appreciated that Mx is just a name used in this disclosure to represent any reference point. 3GPP does not have this interface defined yet.

An interface SGmb between the MBMSF 14 and the BMSC 20 may also be a service-based interface. It is diameter based and defined in 3GPP TS 29.061 V15.2.0. However this SGmb interface is out of this disclosure scope, because it is associated with the BMSC 20, instead of the network node.

MBMS System Architecture with MBMS-IWF

FIG. 5a depicts a MBMS system architecture with MBMS-IWF using the reference point representation showing how the NFs interact with each other. On the other hand, FIG. 5b depicts a MBMS system architecture with MBMS-IWF using the service-based interface representation.

In this embodiment, the same service-based interface as above, e.g., Nxx, is used between the network node, e.g., AMF 22, and the MBMS-IWF 16.

A reference point, e.g., Sm, may be used between the MBMS-IWF 16 and the MBMS-GW 20. For instance, the Sm may be a General Packet Radio Service (GPRS) tunneling protocol version 2 (GTPv2) based interface.

An interface SGmb between the MBMSF 16 and the BMSC 20 may also be a service-based interface. It is diameter based and defined in 3GPP TS 29.061 V15.2.0. However this SGmb interface is out of this disclosure scope, because it is associated with the BMSC 20, instead of the network node.

### MBMS Session Control Procedure

An MBMS session Control Procedure may also be referred to as a method performed by the network node, e.g., AMF 22 and/or the MBMS node, e.g., the MBMSF 14 and/or the MBMS-IWF 16, for communicating with each other. The MBMS Session Control Procedure will be illustrated with respect to the above different MBMS system architectures shown in FIG. 3a-FIG. 3b and FIG. 5a-FIG. 5b, respectively.

The MBMS Session Control Procedure with respect to the embodiments shown in FIG. 3a-FIG. 3b will be explained herein, the MBMS node in this embodiment is the MBMSF 14.

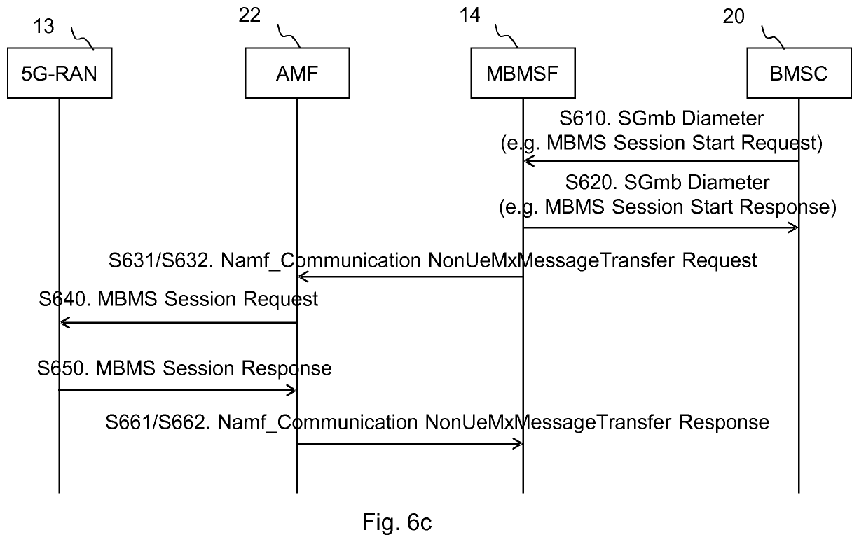

The method actions performed by a network node for communicating with a MBMS node according to embodiments herein will now be described with reference to a flowchart depicted in FIG. 6a. The actions do not have to be taken in the order stated below, but may be taken in any suitable order. Actions performed in some embodiments may be marked with dashed boxes.

Action S601. In embodiments herein, the network node receives, via a service-based interface between the network node and the MBMS node, an MBMS session request from the MBMS node. In this embodiment, the MBMS node is the MBMSF 14.

The MBMS session request may be associated with a service operation in a service, e.g., a Namf_Communication service. In other words, the MBMS session request may belong to a service operation in a service, e.g., a Namf_Communication service. As shown in Table 1 below, the newly added service operation may be called a NonUeMxMessageTransfer service operation.

TABLE 1

| Service Name | Service Operations | Operation Semantics | Example Consumer(s) |
|---|---|---|---|
| Namf_Communication | NonUeMxMessageTransfer | Request/Response | MBMSF, MBMS-IWF |
| | UEContextTransfer | Request/Response | Peer AMF |
| | RegistrationCompleteNotify | Subscribe/Notify | Peer AMF |
| | N1MessageNotify | Subscribe/Notify | AMF, LMF, |
| | N1N2MessageSubscribe | | |
| | N1N2MessageUnSubscribe | | |
| | N1N2MessageTransfer | Request/Response | SMF, SMSF, LMF |
| | NonUeN2MessageTransfer | Request/Response | LMF, CBCF, PWS-IWF |
| | NonUeN2InfoSubscribe | Subscribe/Notify | CBCF, PWS-IWF |
| | NonUeN2InfoUnSubscribe | | |
| | N2InfoNotify | | LMF, AMF |
| | NonUeN2InfoNotify | | LMF, CBCF, PWS-IWF |
| | EBIAssignment | Request/Response | SMF |
| | AMFStatusChangeSubscribe | Subscribe/Notify | SMF, PCF, NEF, SMSF, UDM |
| | AMFStatusChangeUnSubscribe | Subscribe/Notify | SMF, PCF, NEF, SMSF, UDM |
| | AMFStatusChangeNotify | Subscribe/Notify | SMF, PCF, NEF, SMSF, UDM |
| Namf_EventExposure | Subscribe | Subscribe/Notify | NEF, SMF, PCF, UDM |
| | Unsubscribe | Subscribe/Notify | NEF, SMF, PCF, UDM |
| | Notify | Subscribe/Notify | NEF, SMF, PCF, UDM |
| Namf_MT | EnableUEReachability | Request/Response | SMSF |
| Namf_Location | ProvideLocation | Request/Response | GMLC |
| | EventNotify | Subscribe/Notify | GMLC |

The above Table 1 gives a picture of AMF services including the Namf_Communication service. This Namf_Communication service enables an NF to communicate with a wireless device, e.g., UE, through N1 Non-access stratum (NAS) messages or with the RAN (both UE and non UE specific). The service operations defined above allow the NF to communicate with the wireless device, e.g., UE and/or the RAN. Key functionalities of this NF service may include:
Provide service operations for transporting N1 messages to the UE;
Allow NFs to subscribe and unsubscribe for notifications of specific N1 messages from the wireless device, e.g., UE;
Allow NFs to subscribe and unsubscribe for notifications about specific information from Access Network (AN);
Provide service operations for initiating N2 messages towards the RAN;
Security Context Management; and
UE information management and transfer (including its security context)

More definitions for the service operations apart from the NonUeMxMessageTransfer can be found in either 3GPP TS 29.518 V15.0.0, or 3GPP TS 23.502 V15.2.0, clause 5.2.2.2.1.

The newly added NonUeMxMessageTransfer service operation is used for an MBMS session control procedure, such as MBMS Session Start or MBMS Session Update or MBMS Session Stop procedure. It is noted that though the AMF MBMS specific service operation is called NonUeMxMessageTransfer in this disclosure, it can be in any other name.

Action S602. The network node sends via the service-based interface an MBMS session response to the MBMS node.

The response may also be associated with a service operation in a service, such as the Namf_Communication service. Reusing the Namf_Communication service brings further technical advantage of being compatible with the existing standard.

The network node may be an AMF 22.

Comparing with non-service-based interface between a between a network node in a service-based CN network and a MBMS node, the network node with a service-based interface towards the MBMS node is less complicated, and such a network node will take the advantage of a service-based CN, e.g., 5GC. Adding more and more non-service-based interfaces surrounding the network node in a service-based CN network will make the network node more and more complicated and does not take advantage of a service-based CN.

Embodiments herein provide a network node, e.g., the AMF 22, with a service-based interface towards a MBMS node. The newly introduced service-based interface enables a less complicated network node, e.g., the AMF 22, and takes the advantage of a service-based CN.

The method actions performed by a MBMS node, e.g., the MBMSF 14, for communicating with a network node according to embodiments herein will now be described with reference to a flowchart depicted in FIG. 6b. The actions do not have to be taken in the order stated below, but may be taken in any suitable order. Actions performed in some embodiments may be marked with dashed boxes.

Action S603. The MBMSF 14 may receive via a service-based interface a diameter request from a BMSC 20.

Action S604. The MBMSF 14 may send via the service-based interface a diameter response to the BMSC 20.

Action S605. The MBMS node sends, via a service-based interface between the network node and the MBMS node, the MBMS session request to the network node.

Action S606. The MBMS node receives via the service-based interface the MBMS session response from the network node.

The MBMS session request and/or the MBMS session response may be associated with a service operation in a service. The service may be a Namf_Communication service.

The MBMS node may be a logical NF.

Embodiments herein provide the MBMS node with the service-based interface towards the network node, e.g., the AMF 22. The service-based interface enables a less complicated network node, e.g., the AMF 22, and takes the advantage of a service-based CN.

FIG. 6c is a combined signalling scheme and flowchart according to embodiments herein showing the MBMS session control procedure without MBMS-IWF 16. In this embodiment, the AMF 22 is used as an example of the network node. To give the reader a complete picture of the MBMS, apart from the AMF 22 and the MBMSF 14, other related NFs or devices, such as the 5G-RAN 13 and BMSC 20, are also illustrated herein.

Action S610. The MBMSF 14 may receive via a service-based interface, e.g., SGmb, a diameter request, e.g., a diameter Re-Auth-Request command, from a BMSC 20. The diameter request is for activating an MBMS session or updating an active MBMS session or stopping an active MBMS session. The diameter request may comprise MBMS session delivery attributes that will be used later on. Diameter is a known protocol used for authentication, authorization, and accounting. More details of the Re-Auth-Request are described in 3GPP TS 29.061 V15.2.0, clause 20.4.1. This is an example of action 603 in FIG. 6b.

Action S620. The MBMSF 14 may send service-based interface, e.g., SGmb, a diameter response to the BMSC 20. For instance, the diameter response may be a diameter Re-Auth-Answer command in response to the Re-Auth-Request. More details of the Re-Auth-Answer are described in 3GPP TS 29.061 V15.2.0, clause 20.4.2. This is an example of action 604 in FIG. 6b.

Action S631. The MBMSF 14 may send via the service-based interface between the AMF 22 and the MBMSF 14, the MBMS session request to the AMF 22. This is an example of action 605 in FIG. 6b.

Thus, a less complicated network node in a service-based CN is provided by the embodiments herein, by virtue of the newly added MBMS node with a service-based interface towards the network node.

The MBMS session request may contain MBMS session delivery attributes that comprised in the diameter request from the BMSC 20. The MBMS session delivery attributes may comprise one or more of: MBMS Service Area, MBMS Temporary Mobile Group Identity, MBMS Session Identifier, MBMS Session QoS profile, MBMS IP Multicast Distribution, depending on it is related to MBMS session activation or MBMS session update or MBMS session stop. For instance, The MBMS Service Area may be used by the AMF 22 to determine to which 5G-RAN nodes an MBMS session request will be sent.

Optionally, the MBMSF 14 may further select the AMF 22 among other AMFs to send the MBMS session request, based on the diameter request from the BMSC 20. The selection may be done by using any prior art method, such as 3GPP TS 23.246.

Optionally, the MBMSF 14 may further determine whether or not the service operation NonUeMxMessageTransfer is successfully initiated or failed, e.g., the MBMS session request cannot be fulfilled. For instance, the MBMSF 14 may determine that the service operation is failed when application errors, e.g., a context of the MBMS session cannot be found, i.e., CONTEXT_NOT_FOUND, occur.

Action S632. On the other side, the AMF 22 may receive, via the service-based interface between the AMF 22 and the MBMSF 14, the MBMS session request from the MBMSF 14. This is an example of action 601 in FIG. 6a.

The AMF 22 may store the MBMS session attributes, and/or create an MBMS session context in case that the MBMS session does not exist.

Action S640. Upon the request for the MBMS from the MBMSF 14, the AMF 22 may send an MBMS session request to nodes in a 5G-RAN 13.

Action S650. Then the nodes in the 5G-RAN 13 may respond to the MBMS session request received from the AMF 22. The above actions S640-S650 may be implemented in any means according to prior art.

Action S661. Then the AMF 22 may send via the service-based interface an MBMS session response to the MBMSF 14. This is an example of action 602 in FIG. 6a.

In an implementation form, the MBMS session response may also be associated to the above NonUeMxMessageTransfer service operation.

The MBMS session response may indicate if the service operation NonUeMxMessageTransfer has been successfully initiated or failed. For instance, a body of the MBMS session response may indicate application errors, e.g., CONTEXT_NOT_FOUND. Examples of the HTTP status codes may be 4xx or 5xx, such as “400 Bad Request”, “404 Not Found”, “500 Internal Server Error”, “503 Service Unavailable” etc.

If the service operation NonUeMxMessageTransfer has been successfully initiated, the AMF 22 may respond a “200 OK” to the MBMSF 14, as shown in FIG. 6d from the HTTP/2 layer perspective. Otherwise, the AMF 22 may respond one of HTTP status codes together with the body.

Though the MBMS session response to the MBMSF 14 is illustrated after the actions S640-S650 in FIG. 6c, such a response may also be sent prior to the actions S640-S650. Namely, the AMF 22 may immediately respond after the action S632.

Action S662. The MBMSF 14 may receive via the service-based interface the above MBMS session response from the AMF 22. This is an example of action 606 in FIG. 6b.

Thus, a less complicated network node in a service-based CN, e.g., AMF 22, is enabled by the embodiments herein by virtue of the service-based interface between the MBMS node and the network node.

In an implementation form, the MBMS session request may be associated to the above NonUeMxMessageTransfer service operation. The MBMS session request may comprise MBMS session transfer request information to trigger an MBMS Session Start or MBMS Session Update or MBMS Session Stop procedure. As shown in FIG. 6d, from the HTTP/2 layer perspective, the MBMS session request herein may be an HTTP/2 POST request, e.g., Post {apiRoot}/namf-comm/v1/non-ue-mx-messages/transfer. The “apiRoot” is defined in 3GPP TS 29.501 V15.0.0, clause 4.4.

MBMS Session Control Procedure with respect to the embodiments shown in FIG. 5a-FIG. 5b will be explained here, the MBMS node in this embodiment is the MBMS-IWF 16.

The method actions performed by a network node for communicating with a MBMS node according to embodiments herein is the same as FIG. 6a, apart from that the MBMS node in this embodiment is the MBMS-IWF 16.

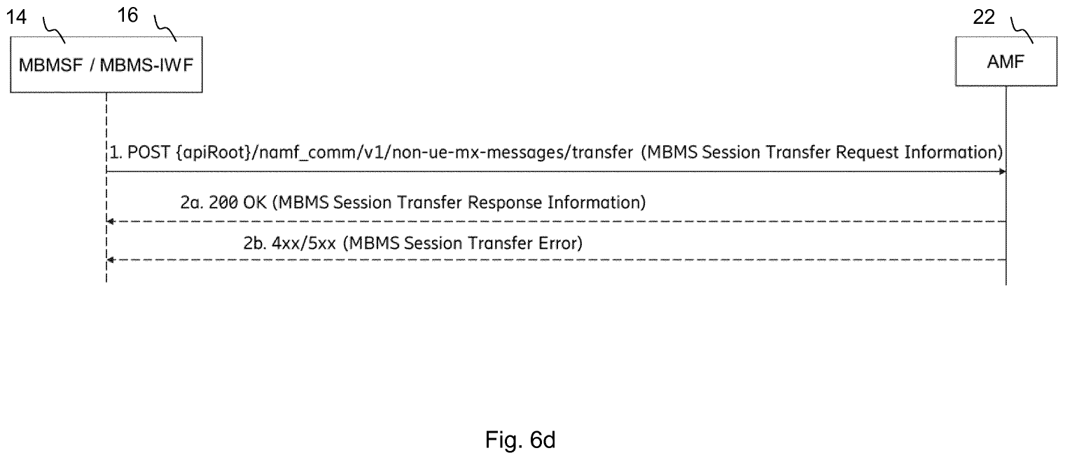

The method actions performed by a MBMS node, e.g., the MBMS-IWF 16, for communicating with a network node according to embodiments herein will now be described with reference to a flowchart depicted in FIG. 7a. The actions do not have to be taken in the order stated below, but may be taken in any suitable order. Actions performed in some embodiments may be marked with dashed boxes.

Action S701. The MBMS node may receive via a reference point an MBMS session Request from a BMSC.

Action S02. The same as the actions S605 and S631, the MBMS node may send, via a service-based interface between the network node and the MBMS node, an MBMS session request to the network node.

Optionally, the MBMS node may further select the AMF 22 among other AMFs to send the MBMS session request, based on the diameter request from the BMSC 20.

Optionally, the MBMS node may further determine whether or not the service operation NonUeMxMessageTransfer is successfully initiated or failed. For instance, the MBMS node may determine that the service operation is failed when application errors, e.g., a context of the MBMS session cannot be found, i.e., CONTEXT_NOT_FOUND, occur.

Action S703. The same as the actions S606 and S662, the MBMS node may receive via the service-based interface an MBMS session response from the network node.

Action S704. The MBMS node may send via the reference point an MBMS session Response to the BMSC.

FIG. 7b is a combined signalling scheme and flowchart according to embodiments herein showing the MBMS session control procedure with MBMS-IWF 16. Again the AMF 22 will be used as an example of the network node. For the same reason as in FIG. 6c, apart from the AMF 22 and the MBMS-IWF 16, other related NFs or devices, such as the 5G-RAN 13, MBMS-GW 16 and BMSC 20, are also illustrated.

Action S710. The BMSC 20 may send via a service-based interface, e.g., SGmb, a diameter request, e.g., Re-Auth-Request command, to the MBMS-GW 18 to activate an MBMS session or to update an active MBMS session or to stop an active MBMS session. The diameter request may be the same as that in the action S610.

Action S720. The MBMS-GW 18 may send via the service-based interface, e.g., SGmb, a diameter response, e.g., Re-Auth-Answer command, to the BMSC 20 in response to the diameter request. The diameter response may be the same as that in the action S620.

Action S730. The MBMS-GW 18 may send via a reference point, e.g., Sm, an MBMS session Request, e.g., a GTPv2 MBMS Session Request, to the MBMS-IWF 16. This is an example of action S701 in FIG. 7a.

Details of the GTPv2 MBMS Session Request are described in 3GPP TS 29.274 V15.2.0.

Action S741. This is an example of action S702 in FIG. 7a. The MBMS-IWF 16 may select an AMF 22 based on information in the MBMS Session Request received from the MBMS-GW 18. The MBMS-IWF 16 may further determine whether or not the service operation NonUeMxMessageTransfer is successfully initiated or failed. Then the MBMS-IWF 16 sends, via a service-based interface between the AMF 22 and the MBMS-IWF 16, an MBMS session request to the AMF 22. The request for the MBMS is the same as that in the actions S605 and S631.

Action S742. On the other side, the AMF 22 may receive, via the service-based interface between the AMF 22 and the MBMS-IWF 16, the MBMS request from the MBMS-IWF 16. This action is the same as the actions S601 and S632.

Action S750. The AMF 22 may send an MBMS session request to nodes in the 5G-RAN 13.

Action S760. The nodes in the 5G-RAN 13 may respond to the MBMS session request received from the AMF 22.

The above actions S750-S760 may be implemented in any means according to prior art.

Action S771. The AMF 22 may send, via a service-based interface between the AMF 22 and the MBMS-IWF 16, an MBMS session response to the MBMS-IWF 16 indicating if the NonUeMxMessageTransfer has been successfully initiated or the MBMS request cannot be fulfilled. This action is the same as the actions S602 and S661.

Action S772. This is an example of action S703 in FIG. 7a. Then the MBMS-IWF 16 may receive via the service-based interface between the AMF 22 and the MBMS-IWF 16, the above MBMS session response from the AMF 22. This action is the same as the actions S606 and S662.

Action S780. The MBMS-IWF 16 may send via the reference point, e.g., Sm, an MBMS session Response, e.g., a GTPv2 MBMS Session Response, to the MBMS-GW 18. This is an example of action S704 in FIG. 7a.

Details of the GTPv2 MBMS Session Response are described in 3GPP TS 29.274 V15.2.0.

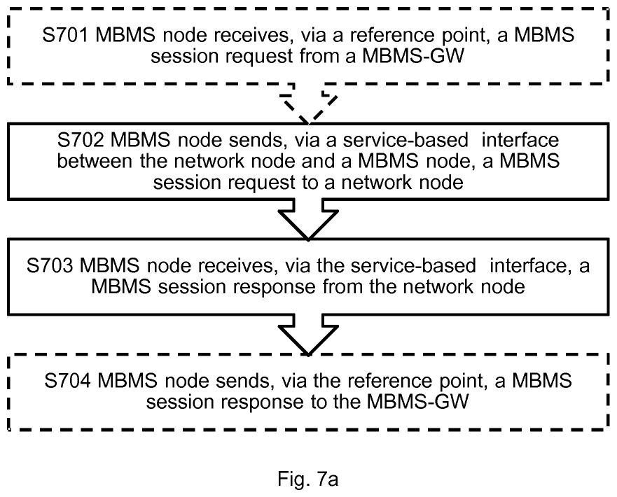

FIG. 8 is a block diagram depicting the network node, e.g., THE AMF 22, for communicating with a MBMS node according to embodiments herein.

The network node may comprise the service-based interface, e.g., the Namf, which is between the network node and the MBMS node. The service-based interface may use the protocol stack as shown in FIG. 4. An example of the network node comprises an AMF 22.

The network node may comprise processing circuitry 801, e.g., one or more processors, configured to perform the methods herein.

The network node may comprise a receiving module 810, e.g., a receiver or transceiver. The network node, the processing circuitry 801, and/or the receiving module 810 may be configured to receive, via the service-based interface between the network node and the MBMS node, an MBMS session request from the MBMS node.

The network node and/or the processing circuitry 801 may further be configured to select the network node among other network nodes to send the MBMS session request, based on the diameter request from the BMSC 20.

The network node and/or the processing circuitry 801 may further be configured to determine whether or not the service operation NonUeMxMessageTransfer is successfully initiated or failed, e.g., in case that the request for the MBMS cannot be fulfilled. For instance, the MBMS node may determine that the service operation is failed when application errors, e.g., a context of the MBMS session cannot be found, i.e., CONTEXT_NOT_FOUND, occur.

The network node may comprise a sending module 811, e.g., a transmitter or a transceiver. The network node, the processing circuitry 801, and/or the sending module 811 may be configured to send via the service-based interface an MBMS session response to the MBMS node, e.g., the MBMSF 14 and/or the MBMS-IWF 16.

The MBMS session request and/or MBMS session response may be associated with a service operation in a service, such as a Namf_Communication service.

The network node may further comprise a memory 804. The memory comprises one or more units to be used to store data on, such as the service, the request, the response, and/or the related parameters to perform the methods disclosed herein when being executed. Thus, the network node may comprise the processing circuitry 801 and the memory 804, said memory 804 comprising instructions executable by said processing circuitry 801 whereby said network node is operative to perform the methods herein.

The methods according to the embodiments described herein for the network node are respectively implemented by means of e.g., a computer program product 805 or a computer program 805, comprising instructions, i.e., software code portions, which, when executed on at least one processor, cause the at least one processor to carry out the actions described herein, as performed by the network node. The computer program product 805 may be stored on a computer-readable storage medium 806, e.g., a disc, USB or similar. The computer-readable storage medium 806, having stored thereon the computer program product 805, may comprise the instructions which, when executed on at least one processor, cause the at least one processor to carry out the actions described herein, as performed by the network node. In some embodiments, the computer-readable storage medium may be a non-transitory computer-readable storage medium.

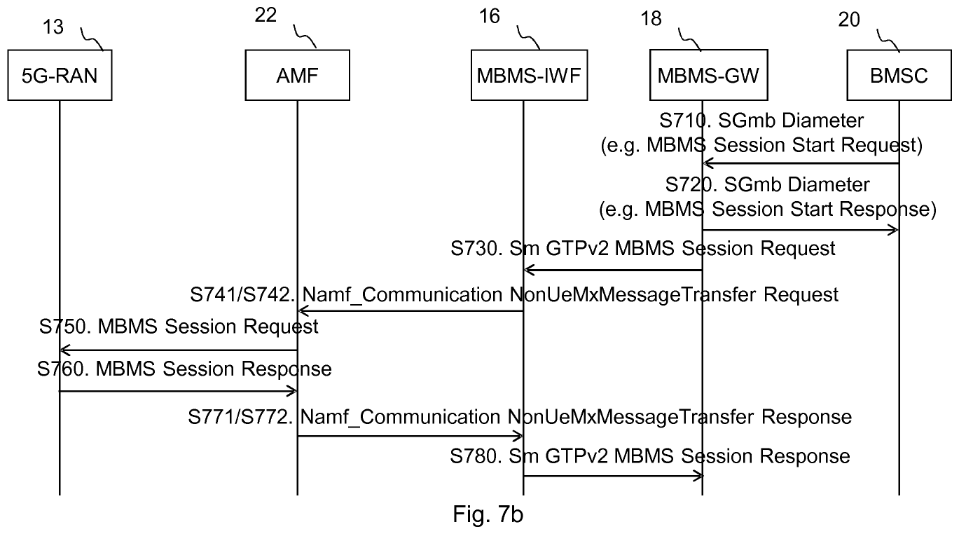

FIG. 9 is a block diagram depicting the MBMS node, e.g., the MBMSF 14 and/or the MBMS-IWF 16, for communicating with the network node according to embodiments herein.

The MBMS node may comprise the service-based interface, e.g., Nmbms, which is between the network node and the MBMS node. The service-based interface may use the protocol stack as shown in FIG. 4. An example of the network node comprises an AMF 22. The MBMS node may be a logical NF.

The MBMS node may comprise processing circuitry 901, e.g., one or more processors, configured to perform the methods herein.

The MBMS node may comprise a sending module 911, e.g., a transmitter or a transceiver. The MBMS node, the processing circuitry 901 and/or the sending module 911 may configured to send, via the service-based interface between the network node and the MBMS node, an MBMS session request to the network node.

The MBMS node may comprise a receiving module 910, e.g., a receiver or transceiver. The MBMS node in the core network, the processing circuitry 901 and/or the receiving module 910 may configured to receive via the service-based interface an MBMS session response from the network node.

The MBMS session request and/or the MBMS session response may be associated with a service operation in a service, such as a Namf_Communication service.

The MBMS node in the core network, the processing circuitry 901 and/or the receiving module 910 may further configured to receive via a reference point a diameter request from a BMSC 20.

The MBMS node, the processing circuitry 901 and/or the sending module 911 may further configured to send via the reference point a diameter response to the BMSC.

The MBMS node in the core network, the processing circuitry 901 and/or the receiving module 910 may further configured to receive via a reference point an MBMS session request from a MBMS-Gateway (MBMS-GW).

The MBMS node, the processing circuitry 901 and/or the sending module 911 may further configured to send via the reference point an MBMS session response to the MBMS-GW.

The MBMS node may further comprise a memory 904. The memory comprises one or more units to be used to store data on, such as the requests, the responses, and/or the related parameters to perform the methods disclosed herein when being executed. Thus, the MBMS node may comprise the processing circuitry 901 and the memory 904, said memory 904 comprising instructions executable by said processing circuitry 901 whereby said radio network node is operative to perform the methods herein.

The methods according to the embodiments described herein for the MBMS node are respectively implemented by means of e.g., a computer program 905 or a computer program product 905, comprising instructions, i.e., software code portions, which, when executed on at least one processor, cause the at least one processor to carry out the actions described herein, as performed by the MBMS node in the core network. The computer program product 905 may be stored on a computer-readable storage medium 906, e.g., a disc or similar. The computer-readable storage medium 906, having stored thereon the computer program product 905, may comprise the instructions which, when executed on at least one processor, cause the at least one processor to carry out the actions described herein, as performed by the MBMS node in the core network. In some embodiments, the computer-readable storage medium may be a non-transitory computer-readable storage medium.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

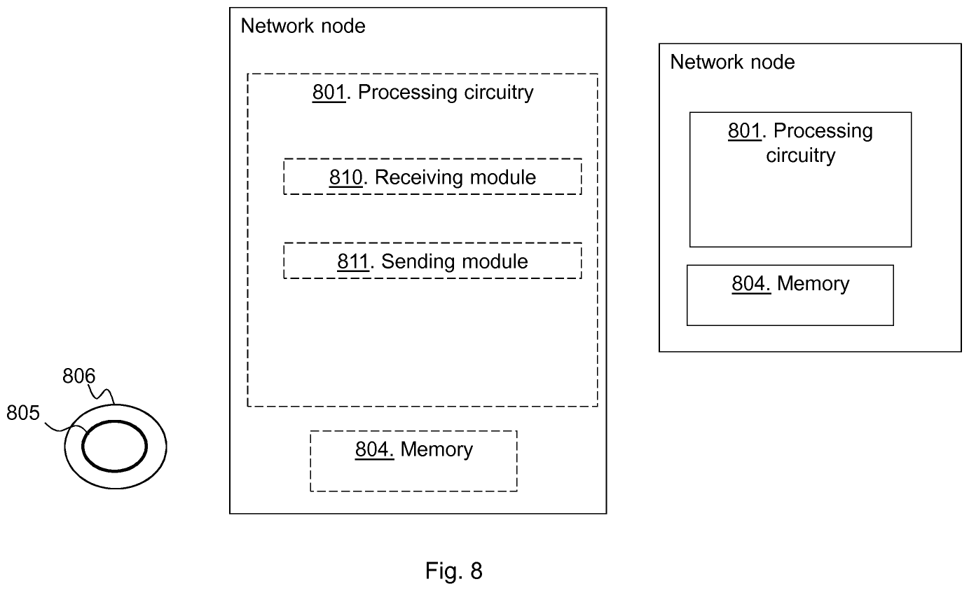

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network nodes herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the wireless device 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

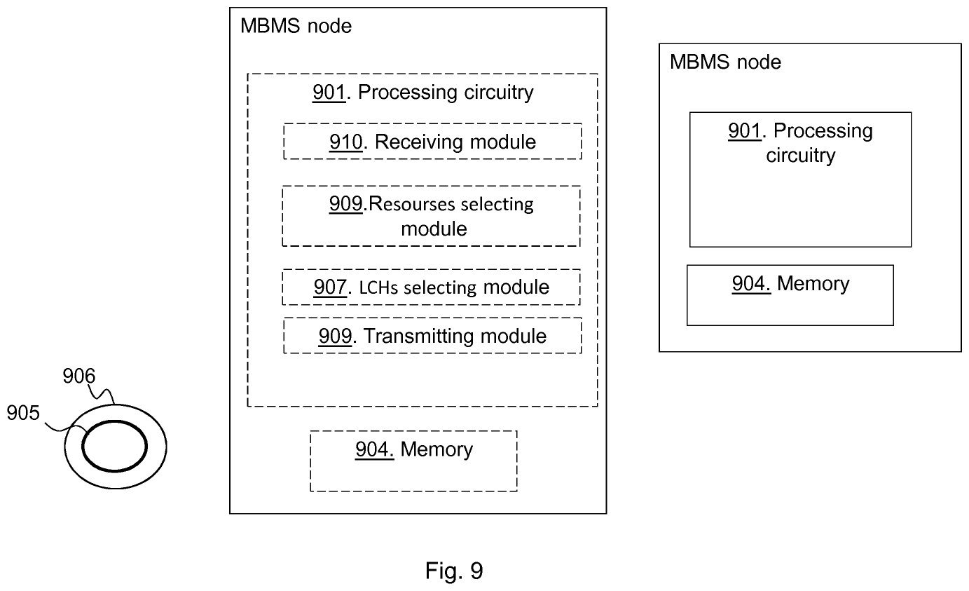

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing ofs via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve transmissions as number of transitions between states may be reduced and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

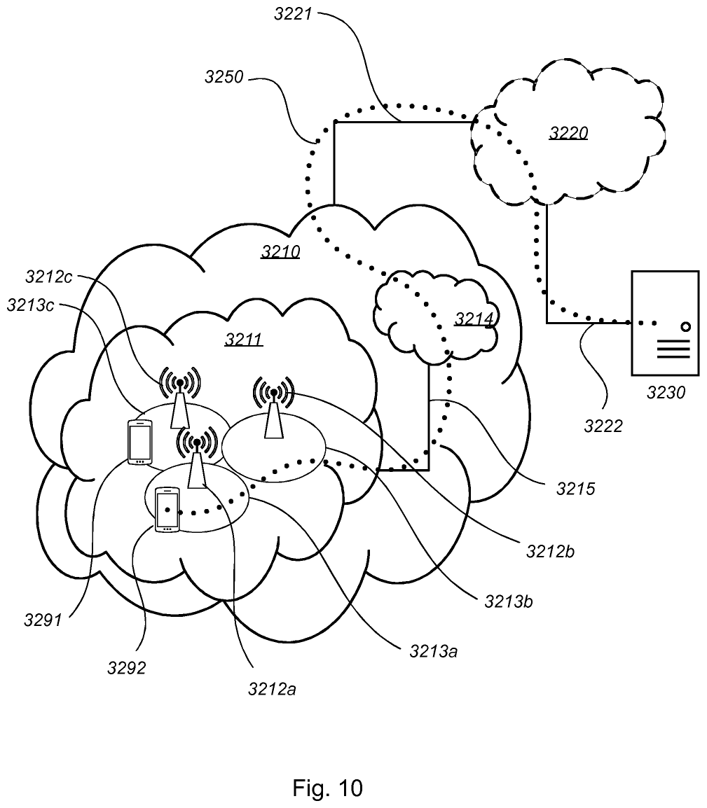

FIG. 12 is a flowchart illustrating a method implemented in a communication system, in accordance with one embodiment. The communication system includes a host computer, a base station and a UE which may be those described with reference to FIG. and FIG. 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

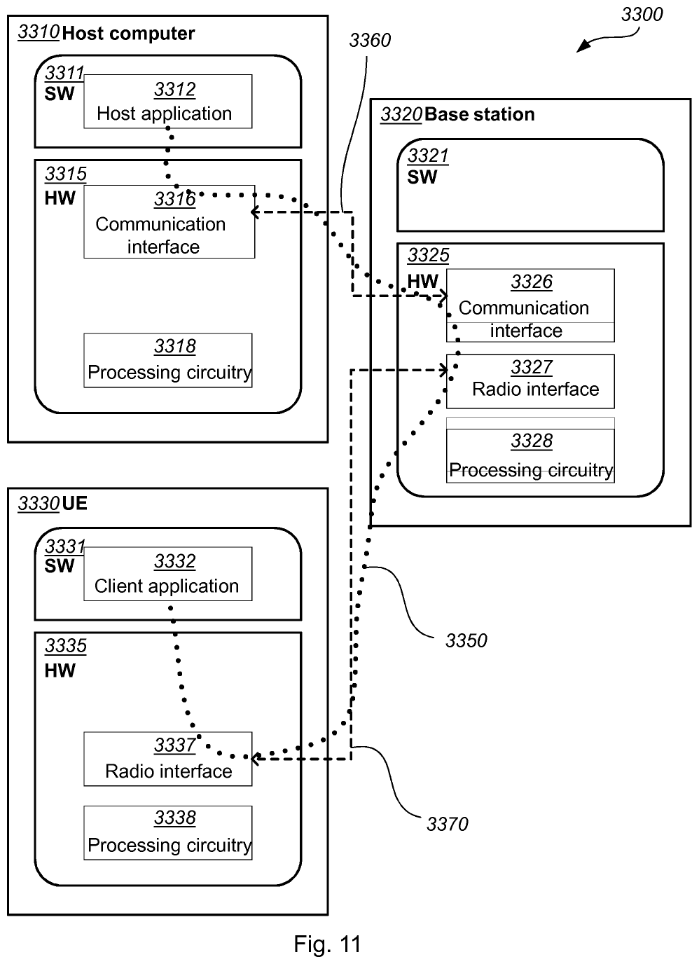

FIG. 13 is a flowchart illustrating a method implemented in a communication system, in accordance with one embodiment. The communication system includes a host computer, a base station and a UE which may be those described with reference to FIG. and FIG. 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

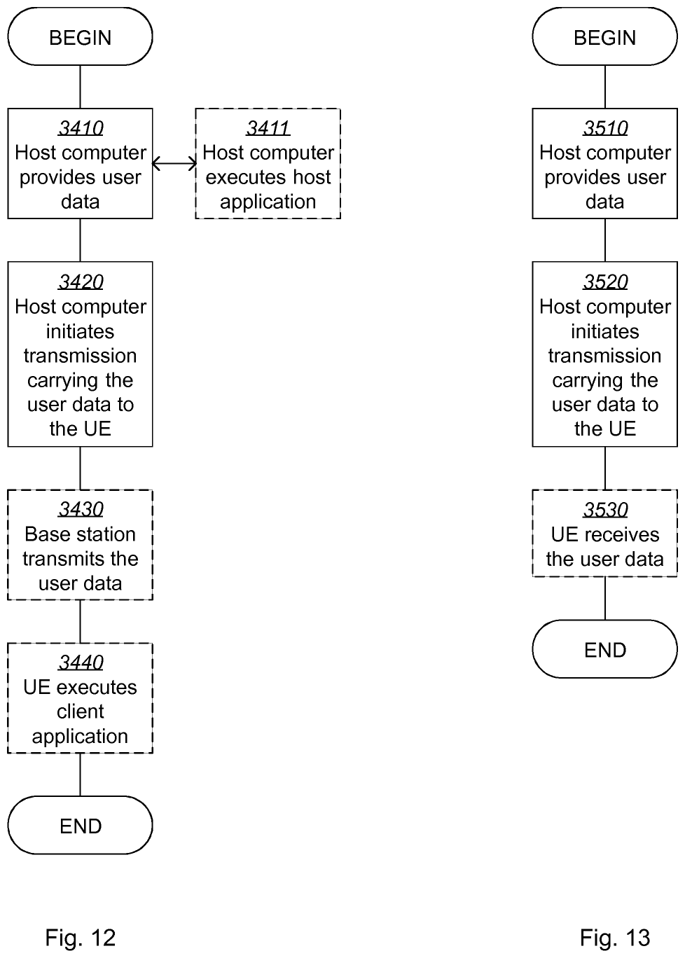

FIG. 14 is a flowchart illustrating a method implemented in a communication system, in accordance with one embodiment. The communication system includes a host computer, a base station and a UE which may be those described with reference to FIG. and FIG. 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

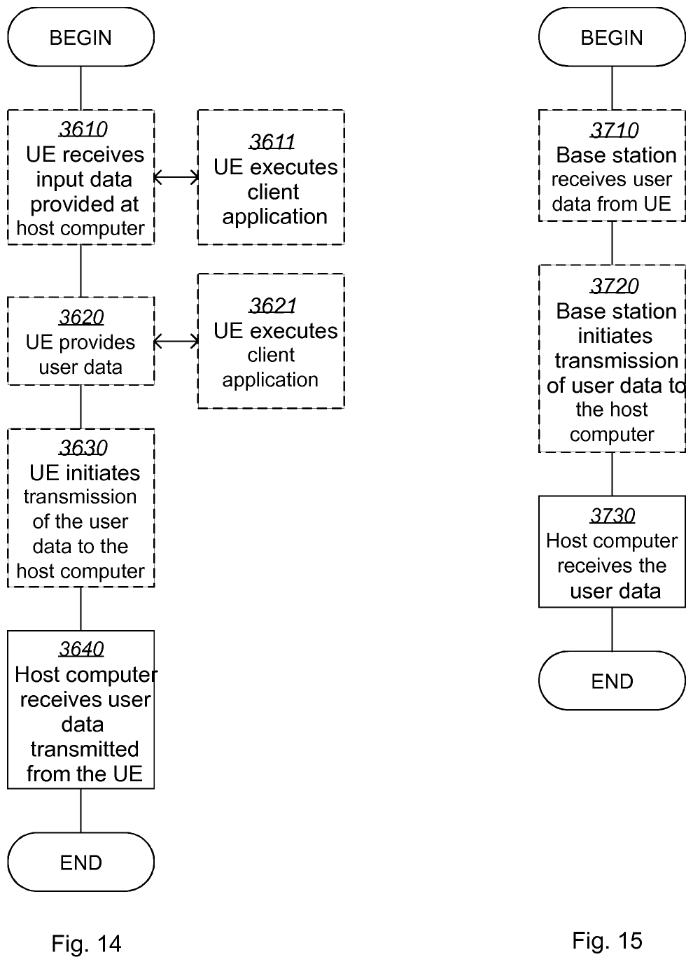

FIG. 15 is a flowchart illustrating a method implemented in a communication system, in accordance with one embodiment. The communication system includes a host computer, a base station and a UE which may be those described with reference to FIG. and FIG. 11. For simplicity of the present disclosure, only drawing references to FIG. will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a network node for communicating with a Multimedia Broadcast and Multicast Service, MBMS, node, the method comprising:
receiving, via a service-based interface between the network node and the MBMS node, an MBMS session request from the MBMS node; and
sending via the service-based interface the MBMS session response to the MBMS node.

2. The method according to claim 1, wherein the MBMS session request and/or MBMS session response are associated with a service operation in a service.

3. The method according to claim 2, wherein the service is a Namf_Communication service.

4. The method according to claim 1, wherein the network node comprises an Access and Mobility Management Function, AMF.

5. A method performed by a Multimedia Broadcast and Multicast Service, MBMS, node for communicating with a network node, the method comprising:
sending, via a service-based interface between the network node and the MBMS node, the MBMS session request to the network node; and
receiving via the service-based interface an MBMS session response from the network node.

6. The method according to claim 5, wherein the MBMS session request and/or MBMS session response are associated with a service operation in a service.

7. The method according to claim 6, wherein the service is a Namf_Communication service.

8. The method according to claim 5, wherein the MBMS node is a logical network function.

9. The method according to claim 5, the method further comprising:
receiving via a reference point a diameter request from a Broadcast Multicast Service Centre, BMSC; and
sending via the reference point a diameter response to the BMSC.

10. The method according to claim 5, the method further comprising:
receiving via a reference point an MBMS session request from a MBMS-Gateway, MBMS-GW; and
sending via the reference point an MBMS session response to the MBMS-GW.

11-20. (canceled)

21. A network node comprising processing circuitry configured to:
receive, via a service-based interface between the network node and a Multimedia Broadcast and Multicast Service, MBMS, node, the MBMS session request from the MBMS node; and
send via the service-based interface the MBMS session response to the MBMS node.

22. The network node according to claim 21, wherein the MBMS session request and/or MBMS session response are associated with a service operation in a service.

23. The network node according to claim 22, wherein the service is a Namf_Communication service.

24. The network node according to claim 21, wherein the network node comprises an Access and Mobility Management Function, AMF.

25. A Multimedia Broadcast and Multicast Service, MBMS, node comprising processing circuitry configured to:
send, via a service-based interface between a network node and the MBMS node, the MBMS session request to the network node; and
receive via the service-based interface an MBMS session response from the network node.

26. The MBMS node according to claim 25, wherein the MBMS session request and/or MBMS session response are associated with a service operation in a service.

27. The MBMS node according to claim 26, wherein the service is a Namf_Communication service.

28. The MBMS node according to claim 25, wherein the MBMS node is a logical network function.

29. The MBMS node according to claim 25, the processing circuitry further configured to:
receive via a reference point a diameter request from a Broadcast Multicast Service Centre, BMSC; and
send via the reference point a diameter response to the BMSC.

30. The MBMS node according to claim 25, the processing circuitry further configured to:
receive via a reference point an MBMS session request from a MBMS-Gateway, MBMS-GW; and
send via the reference point an MBMS session response to the MBMS-GW.

31-33. (canceled)
